(19) United States
(12) Patent Application Publication
(10) Pub. No.: US 2018/0230055 A1
(43) Pub. Date: Aug. 16, 2018

(54) FLY ASH BASED CASTABLE CONSTRUCTION MATERIAL WITH CONTROLLED FLOW AND WORKABILITY RETENTION

(71) Applicant: CEMEX RESEARCH GROUP AG, Bruegg Bei Biel (CH)

(72) Inventors: Alexandre GUERINI, Lyss (CH); Julien CHAPELAT, Biel/Bienne (CH); Cyndy INIGUEZ SANCHES, Zurich (CH)

(21) Appl. No.: 15/751,233

(22) PCT Filed: Aug. 10, 2015
(86) PCT No.: PCT/EP2015/068366

§ 371 Date: Feb. 8, 2018

(51) Int. Cl. C04B 28/02; C04B 14/04; C04B 12/04; C04B 22/06

(52) U.S. Cl. CPC C04B 28/021; C04B 22/062; C04B 12/04; C04B 14/04

(57) ABSTRACT

A castable construction material with controlled flow and workability retention comprising (a) a binder comprising from 75% to 100% by weight of fly ashes comprising from 1.5% to 35% by weight of Ca O and a Lost on Ignition (LOI) value from 0.5% to 5.5% by weight, (b) an activator comprising an alkali hydroxide and an alkali silicate, wherein the activator is from 3% to 25% by weight with respect to the castable construction material, (c) sand, (d) fine aggregates, (e) coarse aggregates, (f) free water and (g) a workability retention agent wherein selected from the group consisting of polycarboxylate ether polymer (PCE), polyamines, polyethylene imines, polyacrylamides, polyacrylate (EO, PO) ester, polymethacrylate (EO, PO) ester, polyammonium derivatives and co-polymers thereof, polydiallyldimethylammonium chloride, benzalkonium chlorides, substituted quaternary ammonium salts, chitosans, caseins and cationically modified colloidal silica.

### FIELD OF THE INVENTION

The field of the invention relates to construction materials. Specifically, the present invention relates to construction materials comprising a binder containing fly ashes, an activator aggregates and a workability retention agent, with controlled placing properties and exhibiting excellent workability retention. The material may optionally comprise ground granulated blast furnace slag and pozzolans.

### BACKGROUND OF THE INVENTION

Construction material based on activated mixture of fly ash, slag or other sources of aluminosilicates, including or not cement clinker have been widely described.

The prior art related to these materials did not disclose aspects related to the workability and the workability retention of these materials. In WO2009024829 some flow properties have been given to show that the slump of those construction mixes could range from some centimeters to 25 cm, but no data are reported on the workability retention and the relation to the rheology parameters of the mixes. It could also be seen on WO2009024829 than high values of slump were related to high water/binder ratio, leading to poor early strength development.

Most of the available literature does not demonstrate any of the requirements of industrial applications (effect of large and small aggregates in large quantity, mixing, placing, segregation risk, transportation, etc.). The available literature is relevant from a chemical and reactivity stand point of view; however scaling up from paste tests (binder+activator+water) to real construction material for industrial application and related constrains is not evident and many systems described as pastes have never been used as construction material due to the difficulty of solving the problems.

One of the known problems of these mixes is that their alkalinity is so high that normal admixture technology (based only on organic polymer like melamine or polycarboxilates-based superplasticizers) cannot be used successfully, and that the stability of the aggregates in the binder (paste) is not ensured leading to important segregation as soon as the slump increases. Segregation is unacceptable for industrial application since it yields heterogeneities and defaults.

In WO 2015/049010 admixture systems are described to provide flow control and workability retention of alkali activated mixtures of fly ash and slag, whereas fly ash represents 10% to 60% of the total binder weight. The solution provided by WO 2015/049010 is applicable to castable material containing sand, fine and coarse aggregates, using an inorganic acid to improve the workability retention. It does not apply to fly ash and slag mixtures for which the slag content in weight % represents less that 40%, preferably less than 30% of the total binder. Binder mixtures of slag of fly ash containing more than 60%, respectively more than 70% in weight of fly ash require higher dosages of an alkali activator (generally expressed by the molarity of silicates in the total water) than mixtures containing less than 60% fly ash in weight. Higher dosages of an activator have the disadvantage that the effect of the organic acid is very limited and cannot be used for workability retention over some minutes.

Castable construction materials shall be offered in a wide range of workability, including pumpable and self compacting (SCC) mixes and a wide range of final strength from 15 to 80 MPa. In addition, the early strength shall be high enough to enable the removal of the framework of moulds in less than 2 days, preferably 1 day or less.

Finally, the workability retention, (e.g. the capacity of the rheology parameters like flow, viscosity, yield stress, etc.) has to be high enough to encompass dispatching problems related to delay, traffic, etc. so the placing properties on the job site are not affected by logistics issues.

### DESCRIPTION OF THE INVENTION

In a first aspect, the present invention provides a castable construction material with controlled flow and workability retention comprising:

(a) a binder comprising from 75% to 100% by weight of fly ashes comprising from 1.5% to 35% by weight of CaO and a Lost on Ignition (LOI) value from 0.5% to 5.5% by weight,
(b) an activator comprising an alkali hydroxide and an alkali silicate, wherein the activator is from 3% to 25% by weight with respect to the castable construction material,
(c) sand,
(d) fine aggregates,
(e) coarse aggregates,
(f) free water and
(g) a workability retention agent wherein selected from the group consisting of polycarboxylate ether polymer (PCE), polyamines, polyethylene imines, polyacrylamides, polyacrylate (EO, PO) ester, polymethacrylate (EO, PO) ester, polyammonium derivatives and co-polymers thereof, polydiallyldimethylammonium chloride, benzalkonium chlorides, substituted quaternary ammonium salts, chitosans, caseins and cationically modified colloidal silica.

The invention provides a new robust construction material, comprising a binder containing mainly fly ashes (over 75% in weight of the total binder). Said new construction material has placing properties that ranks from S1 to SF3 without segregation between aggregates and paste, developing an early strength higher or equal to 2 MPA after 1 day and having workability retention that ranks from 15 minutes to 180 minutes.

In slag fly ash mixes, optimizing the fly ash content in the mix is an advantage for the costs of the mix since fly ash is a widely available very cheap material. However, binders that contain high fly ashes content are more difficult to activate and require thus higher dosages of activators to achieve acceptable strength at 2 days (over 5 MPa) and 28 days strength of at least 17-20 MPa.

High dosages of activators have the consequence that the setting time of the mix containing sand or sand, fine and coarse aggregates is very short and can take place within some minutes after the ingredients are mixed. The invention advantageously provides with a solution to use very high amounts of fly ashes in the binder (over 70% in weight) while maintaining workability retention of at least 15 minutes to 120 minutes, even with high activators dosages.

The construction castable material according to the invention is preferably characterized by a total volume of binder that is located between 350 Kg/m³ and 750 Kg/m³ of casted material.

According to a first embodiment, the castable material according to the invention contains a binder that is only consisting of fly ash and an activator system that has a molar ratio between silicates and total alkalis from 0.25 to 0.5, preferably between 0.3 and 0.4.

The ratio effective water/total binder ratio in Kg is typically located between 0.3 and 0.6, preferably between 0.4 and 0.55. Ratio water/total water in weight below 0.3 do not allow to obtain the expected range of fresh properties (flow, workability retention) and ratio above 0.6 present the risk of segregation of the aggregates and drop of the mechanical resistance.

The dosage of the activator, expressed in molarity of the total water has been found to be the most important parameter influencing the flow (see FIG. 1).

For total binders with slag/fly ash ratio in weight lower than 0.33, the activator is from 6% to 20% by weight with respect to the castable construction material.

Another aspect of the invention is the castable construction material of the first aspect of the invention, comprising an element selected from the group consisting of from 0% to 25% by weight of ground granulated blast furnace slag comprising from 40 to 70% by weight of CaO and from 30 to 60% by weight of SiO₂; from 0% to 25% by weight of pozzolans comprising from 4 to 7% by weight alkali and a Lost on Ignition (LOI) value from 0.01% to 7; and from 0% to 25% in weight of any combination of slag and pozzolans.

Ground granulated blast furnace slag and natural pozzolanas are ground to a fineness of 93% passing 45 microns. Fly ashes are generally used as they arrive without pre mechanical processing.

Another embodiment according to the invention is that the total binder contains at least 75% of fly ash and a maximum of 25% of slag or pozzolans or any combination thereof.

Although most results are presented for various fly ashes or fly ash slags mixes, the invention is not limited to such material and any natural or industrial pozzolans, including metakaolin, calcinated clays, mechanically activated supplementary cementitious materials or recycles glass can be used as components of the binder.

Another aspect of the invention is the castable construction material of the first aspect of the invention, wherein the ratio alkali hydroxide/alkali silicate is from 1:1.5 to 1:2.5.

Another aspect of the invention is the castable construction material of the first aspect of the invention, wherein said alkali hydroxide is in solution, wherein the weight solid content of said alkali hydroxide in the solution is from 30 to 50% by weight and the molarity of said alkali hydroxide in the solution (mole per liter of free added water) is from 2.5 to 6.

Another aspect of the invention is the castable construction material of the first aspect of the invention, wherein the concentration range of said polycarboxylate ether polymer is from 0.12% to 0.75% by weight of total binder.

Another aspect of the invention is the castable construction material of the first aspect of the invention, wherein concentration of fly ashes is from 80% to 100% by weight.

Another aspect of the invention is the castable construction material of the first aspect of the invention, wherein said alkali silicate is sodium metasilicate. Said sodium metasilicate may be pentahydrate sodium metasilicate.

A second aspect of the invention is the castable construction material of the first aspect of the invention, wherein said alkali silicate is in solution, wherein the weight solid content of said alkali silicate in the solution is from 30 to 50% by weight and the molarity of said alkali hydroxide in the solution (mole per liter of free added water) is from 1 to 2.5.

Another aspect of the invention is the castable construction material of the second aspect of the invention, wherein the molarity of said alkali silicate is from 1 to 1.8. The final strength of this castable construction material is above 18 MPa at 28 days and flow or slump is from S1 to S2 according to European Norm EN 12350-2.

Another aspect of the invention is the castable construction material of the second aspect of the invention, wherein the molarity of said alkali silicate is from 1.2 to 2.0. The final strength of this castable construction material is above 18 MPa at 28 days and flow or slump is from S3 to S4 according to European Norm EN 12350-2.

Another aspect of the invention is the castable construction material of the second aspect of the invention, wherein the molarity of said alkali silicate is from 1.5 to 2.2. The final strength of this castable construction material is above 18 MPa at 28 days and flow or slump is from S5 to S6 according to European Norm EN 12350-2.

Another aspect of the invention is the castable construction material of the second aspect of the invention, wherein the molarity of said alkali silicate is from 1.8 to 2.3. The final strength of this castable construction material is above 18 MPa at 28 days and flow or slump is from SF1 and SF2 according to European Norm EN 12350-8.

Another aspect of the invention is the castable construction material of the second aspect of the invention, wherein the molarity of said alkali silicate is from 2 to 2.5. The final strength of this castable construction material is above 18 MPa at 28 days and flow or slump is SF3 according to European Norm EN 12350-8.

Another aspect of the invention is the castable construction material of the first aspect of the invention, wherein said workability retention agent is in a dosage in dry solid content from 0.15 to 0.6%.

Another aspect of the invention is the castable construction material of the first aspect of the invention, wherein said workability retention agent is in a dosage in dry solid content from 0.6 to 1.2%.

Another aspect of the invention is the castable construction material of the first aspect of the invention, wherein said workability retention agent is in a dosage in dry solid content from 1.2 and 1.6%.

### List of Definitions

Hydraulic binder. Material with cementing properties that sets and hardens due to hydration even under water. Hydraulic binders produce calcium silicate hydrates also known as CSH.

Cement. Binder that sets and hardens and bring materials together. The most common cement is the ordinary Portland cement (OPC) and a series of Portland cements blended with other cementitious materials.

Ordinary Portland cement. Hydraulic cement made from grinding clinker with gypsum. Portland cement contains calcium silicate, calcium aluminate and calcium ferroaluminate phases. These mineral phases react with water to produce strength.

Loss on ignition: Weight % loss of a material exposed to around 950° C. for one hour in air.

Hydration. Mechanism through which OPC or other inorganic materials react with water to develop strength. Calcium silicate hydrates are formed and other species like ettringite, monosulfate, Portlandite, etc.

Geopolymerization. Reaction from the interaction of an alkaline solution (activator) with a reactive aluminosilicate powder (binder). Geopolymerization comprises a dissolution phase and a condensation phase developing a 3D net of silico-aluminate materials linked with covalent bonding.

Alkali Activated cements. Low or zero clinker cements activated by the use of caustic alkalis or alkaline salts

Mineral Addition. Mineral admixture (including the following powders: silica fume, fly ash, slags) added to concrete to enhance fresh properties, compressive strength development and improve durability.

Silica fume. Source of amorphous silicon obtained as a byproduct of the silicon and ferrosilicon alloy production. Also known as microsilica.

Fibers. Material used to increase concrete's structural performance. Fibers include: steel fibers, glass fibers, synthetic fibers and natural fibers.

Alumino silicate-by-product (Fly Ash—bottom ash). Alkali reactive binder components that together with the activator form the cementitious paste. These minerals are rich in alumina and silica in both, amorphous and crystalline structure.

Natural Pozzolan. Aluminosilicate material of volcanic origin that reacts with calcium hydroxide to produce calcium silicate hydrates or CSH as known in Portland cement hydration.

Filler inert. Material that does alter physical properties of concrete but does not take place in hydration reaction.

Admixture. Chemical species used to modify or improve concrete's properties in fresh and hardened state. These could be air entrainers, water reducers, set retarders, superplasticizers and others.

Silicate. Generic name for a series of compounds with formula Na₂O.nSiO₂. Fluid reagent used as alkaline liquid when mixed with sodium hydroxide. Usually sodium silicate but can also comprise potassium and lithium silicates. The powder version of this reagent is known as metasilicates and could be pentahydrates or nonahydrates. Silicates are referred as Activator 2 in examples in this application.

Sodium Hydroxide. Inorganic compound with formula NaOH also known as caustic soda or lye that is used for chemical activation. Sodium hydroxide is referred as Activator 1 in examples in this application.

Chemical activation. The use of chemical reagents to promote aluminosilicates dissolution to increase reactivity of binder components.

PCE. Polycarboxylic Acid Co-Polymers used as a class of cement and concrete admixtures, and are comb type polymers that are based on: a polymer backbone made of acrylic, methacrylic, maleic acid, and related monomers, which is grafted with polyoxyalkylene side-chain such as EO and/or PO. The grafting could be, but is not limited to, ester, ether, amide or imide.

Initial dispersant. It is a chemical admixture used in hydraulic cement compositions such as Portland cement concrete, part of the plasticizer and superplasticizer family, which allow a good dispersion of cement particles during the initial hydration stage.

Superplasticizers. It relates to a class of chemical admixture used in hydraulic cement compositions such as Portland cement concrete having the ability to highly reduce the water demand while maintaining a good dispersion of cement particles. In particular, superplasticizers avoid particle aggregation and improve the rheological properties and workability of cement and concrete at the different stage of the hydration reaction.

Coarse Aggregates. Manufactured, natural or recycled minerals with a particle size greater than 8 mm and a maximum size lower than 32 mm.

Fine Aggregates. Manufactured, natural or recycled minerals with a particle size greater than 4 mm and a maximum size lower than 8 mm.

Sand. Manufactured, natural or recycled minerals with a particle size lower than 4 mm.

Concrete. Concrete is primarily a combination of hydraulic binder, sand, fine and/or coarse aggregates, water. Admixture can also be added to provide specific properties such as flow, lower water content, acceleration, etc.

Pourable construction materials. A materials is consider as pourable as soon as its fluidity (with our without vibration) allow to full fill a formwork or to be collocate in a definite surface.

Construction materials. Any material that can be use to build construction element or structure. It includes concrete, masonries (bricks-blocks), stone, ICF, etc.

Structural applications. A construction material is considered as structural as soon as the compressive strength of the material is greater than 25 MPa.

Workability. The workability of a material is measure with a slump test (see below).

Workability retention. Capability of a mix to maintain its workability during the time. The total time required depends on the application and the transportation. Typically, the workability retention is expressed by a time in minutes or hours from which the mix slump remains in the same consistency class.

w/b. Total free water (w) mass in Kg divided by the total binder mass in Kg

Strength development—setting/hardening. The setting time start when the construction material change from plastic to rigid. In the rigid stage the material cannot be poured or moved anymore. After this phase the strength development corresponding to the hardening of the material.

Consistency of the concrete. Consistency reflects the rheological properties of fresh concrete by means of flow and slump as defined below:

TABLE 1
Consistency of concrete (slump) with respect to EN
(European) and FR (French) Norms and normative tests.

| | |
|---|---|
| EN 12350-2 | NF P 18-305 |

| Consistency | slump [mm] | Consistency | slump [mm] |
|---|---|---|---|
| S1 | 10 to 40 | Stiff | 0 to 40 |
| S2 | 40 to 90 | Plastic | 50 to 90 |
| S3 | 100 to 150 | highly plastic | 100 to 150 |
| S4 | 160 to 210 | fluid | >160 |
| S5 | >220 | | |

TABLE 2
Consistency of concrete (flow) with respect to
EN 12350-8 (European) Norm
EN 12350-8

| category | Flow [mm] |
|---|---|
| SF1 | 550-650 |
| SF2 | 660-750 |
| SF3 | 760-850 |

### BRIEF DESCRIPTION OF THE FIGURES

FIG. 1. Shows the dependence between the flow of the fresh castable material and the dosage of the activator for a first embodiment according to the invention where the binder is pure fly ash. Results were obtained by preparing mortar samples with two different fly ashes (see Table 3 for reference fly ash LA and fly ash AND), and a standard 0-4 mm sand, at different activator dosages. Activators were dosed at a constant ratio, and the dosage was expressed as molarity based on the total water. The targeted flow was 150±10 mm and the water demand to achieve was recorded and expressed as water to binder ratio. The water demand—flow of the geopolymer mortar varied significantly when changing the dosage of the activator system.

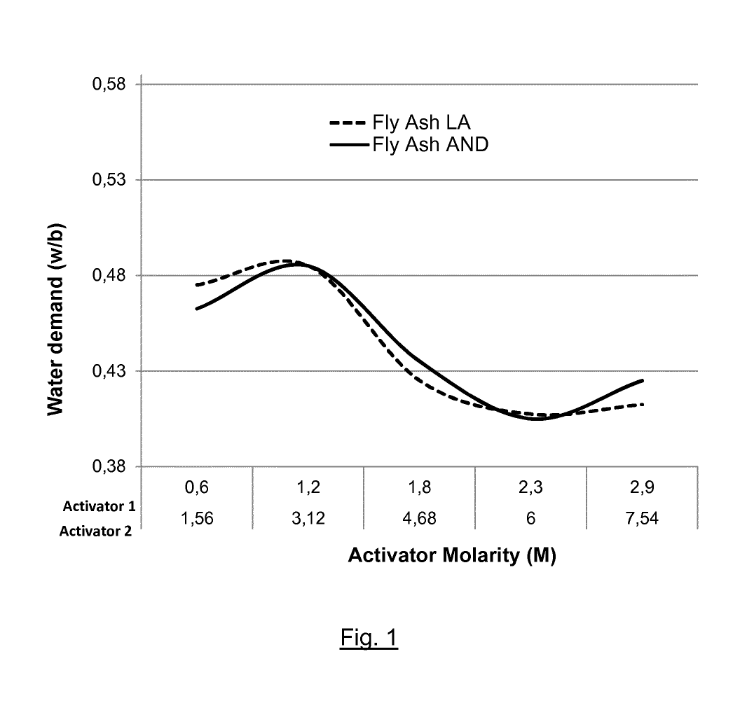

### EXAMPLES OF THE INVENTION

The examples have been prepared using various fly ashes and ground granulated blast furnace slags; chemical compositions are respectively indicated in Tables 3 and 4.

Mortar samples have been prepared using standard 0-4 mm sand, concrete-like samples have been prepared using sand 0-4 mm (natural opr crushed), medium size 4-8 mm round or crushed and large aggregates 8-16 to maximum 25 mm (round or crushed).

Mortars and concrete are mixed using standard equipment, for a time of 20 seconds to some minutes. All mortars and concretes were prepared by mixing all ingredients with no specific sequence or methodology to be close to industrial conditions. Batch sizes vary from some liters to over 100 liters in semi-industrial mini batching plant.

Except when specified, the samples were cured in curing chambers (20° C. min 95% humidity) for 1, 7 and 28 days.

Strength measurements were done using compression tests on cubes for both mortars and concretes (4×4×4 cm for mortars and 16×16×16 cm for concrete).

Flow is measured according to EN 12350-2.

Examples are provided for one cubic meter (1 m³) of corresponding fresh castable material when all ingredients are mixed.

In all examples the total binder content, the slag, fly ash, sand and aggregates content are provided in Kg content in one cubic meter (1 m³) of corresponding fresh castable material when all ingredients are mixed.

The total binder content represents the sum in weight of all puzzolanas (fly ash, slag, etc.) contained in one cubic meter (1 m³) of corresponding fresh castable material when all ingredients are mixed.

The ratio w/b eff represents the ratio in weight between the efficient water (or free water participating to the reaction) and the total binder content for one cubic meter (1 m³) of corresponding fresh castable material when all ingredients are mixed.

Activators and workability retention agent or admixtures are expressed in solid content (SC) weight.

Dosages are expressed in weight ratio (Kg/Kg) between solid content of an activator or workability retention agent or admixture and the total binder content.

TABLE 3
Chemical composition of several fly ashes
samples by X-ray Analysis (fluorescence)

| | MEL | STO | LA | ALE | AND | SA |
|---|---|---|---|---|---|---|
| | 1 | 2 | 3 | 4 | 6 | 9 |
| SiO₂ (%) | 53.42 | 51.38 | 49.14 | 36.49 | 58.64 | 57.39 |
| Al₂O₃ (%) | 33.65 | 25.30 | 26.55 | 19.41 | 23.06 | 22.00 |
| Fe₂O₃ (%) | 5.35 | 8.70 | 6.29 | 6.10 | 6.09 | 6.94 |
| CaO (%) | 1.25 | 4.38 | 5.84 | 23.53 | 1.90 | 2.64 |
| MgO (%) | 0.85 | 0.90 | 2.58 | 5.10 | 1.31 | 1.95 |
| SO₃ (%) | 0.01 | 0.39 | 0.51 | 1.00 | 0.25 | 0.24 |
| Na₂O (%) | 0.28 | 0.40 | 0.84 | 3.05 | 0.25 | 0.73 |
| K₂O (%) | 0.97 | 2.43 | 3.02 | 0.46 | 1.74 | 1.92 |
| TiO₂ (%) | 3.23 | 1.38 | 1.04 | 1.49 | 1.65 | 1.10 |
| P₂O₅ (%) | 0.04 | 0.23 | 0.41 | 0.73 | 0.43 | 0.34 |
| Mn₂O₃ (%) | 0.24 | 0.04 | 0.10 | 0.03 | 0.08 | 0.07 |
| LOI 950 C (%) | 0.52 | 2.89 | 2.90 | 0.99 | 2.50 | 4.92 |
| Sum (%) | 99.81 | 98.41 | 99.22 | 99.71 | 97.89 | 100.24 |
| Glassy | 86.11 | 87.5 | 81.95 | 89.28 | 72.25 | 79.98 |
| Content (%) | | | | | | |

TABLE 4
Chemical composition of ground granulated blast
furnace slag samples X-ray Analysis (florescence)

| | 1 | 2 | 3 | 4 | 5 | 6 | 7 | 8 |
|---|---|---|---|---|---|---|---|---|
| SiO₂ (%) | 34.020 | 32.62 | 32.20 | 32.39 | 35.88 | 34.83 | 36.80 | 34.83 |
| Al₂O₃ (%) | 11.760 | 14.13 | 14.21 | 14.07 | 10.61 | 11.48 | 10.94 | 11.48 |
| Fe₂O₃ (%) | 0.880 | 1.11 | 0.58 | 0.47 | 0.57 | 0.37 | 0.40 | 0.37 |
| CaO (%) | 41.910 | 41.92 | 41.99 | 42.21 | 41.17 | 41.46 | 41.15 | 41.46 |
| MgO (%) | 5.750 | 6.19 | 6.52 | 6.49 | 7.74 | 6.98 | 8.62 | 6.98 |
| SO₃₅ (%) | 2.780 | 2.76 | 1.84 | 1.96 | 1.52 | 2.39 | 2.20 | 2.39 |
| Na₂O (%) | 0.050 | 0.20 | 0.16 | 0.21 | 0.00 | 0.34 | 0.22 | 0.34 |
| K₂O (%) | 0.280 | 0.38 | 0.29 | 0.37 | 0.35 | 0.39 | 0.37 | 0.39 |
| TiO₂ (%) | 1.070 | 0.52 | 0.49 | 0.49 | 0.55 | 1.64 | 0.56 | 1.64 |
| P₂O₅ (%) | 0.430 | 0.01 | 0.00 | 0.01 | 0.01 | 0.01 | 0.38 | 0.32 |
| Mn₂O₃ (%) | 0.010 | 0.31 | 0.29 | 0.36 | 0.42 | 0.32 | 0.01 | 0.01 |
| LOI 950 C (%) | 0 | −0.91 | 0.73 | −0.50 | 0.26 | 0.00 | −0.95 | 0.11 |
| Sum (%) | 98.94 | 99.24 | 99.32 | 98.55 | 99.10 | 100.21 | 100.67 | 100.21 |
| Glassy | 93 | 95 | 91 | 89 | 90 | 95 | 96 | 92 |
| Content (%) | | | | | | | | |

### Example 1—SF1 Reference Concrete Mix

| Material | Unit | Quantity |
|---|---|---|
| Total binder content | kg/m³ | 400 |
| Fly ash reference (table 3) | — | LA |
| Fly ash content | kg/m³ | 400 |
| Slag reference (table 4) | — | — |
| Slag content | kg/m³ | 0 |
| w/b eff | — | 0.41 |
| Slag/fly ash ration | Kg/Kg | — |
| Activator 1 dosage | Molarity Mol | 2.3 |
| Activator 2 dosage | Morality Mol | 6 |
| Total solid content (SC) activators | % SC total binder in | 19 |
| 1 and 2 | weight content | |
| Workability retention agent dosage | % SC total binder | — |
| | content | |
| Sand 0/4 round | kg/m³ | 687 |
| Fine aggregates gravel 4/8 round | kg/m³ | 431 |
| Coarse aggregates gravel 8/16 | kg/m³ | 481 |
| round | | |
| Entrained air | l/m³ | 20 |
| Paste Volume | l/m³ | 373 |

| Results | Unit | Value |
|---|---|---|
| Slump class | — | SF1 |
| Slump flow | mm | 620 |
| Workability retention | min | 10 |
| Strength at 2 days | Mpa | 4.5 |
| Strength at 7 days | Mpa | 12.3 |
| Strength at 28 days | Mpa | 21.5 |

### Example 2—SF1 Reference Concrete Mix with Workability Retention Agent

| Material | Unit | Quantity |
|---|---|---|
| Total binder content | kg/m³ | 400 |
| Fly ash reference (table 3) | — | LA |
| Fly ash content | kg/m³ | 400 |
| Slag reference (table 4) | — | — |
| Slag content | kg/m³ | 0 |
| w/b eff | — | 0.41 |
| Slag/fly ash ration | Kg/Kg | — |
| Activator 1 dosage | Molarity Mol | 2.3 |
| Activator 2 dosage | Morality Mol | 6 |
| Total solid content (SC) of activators | % SC total binder in | 19 |
| 1 and 2 | weight content | |
| Workability retention agent dosage | % SC total binder | 1.2 |
| | content | |
| Sand 0/4 round | kg/m³ | 687 |
| Fine aggregates gravel 4/8 round | kg/m³ | 431 |
| Coarse aggregates gravel 8/16 | kg/m³ | 481 |
| round | | |
| Entrained air | l/m³ | 20 |
| Paste Volume | l/m³ | 373 |
| Results | Unit | Value |
| Slump class | — | |
| Slump flow | mm | 615 |
| Workability retention | min | 45 |
| Strength at 2 days | Mpa | 4.85 |
| Strength at 7 days | Mpa | 11.9 |
| Strength at 28 days | Mpa | 23.1 |

From examples 1 and 2 the effect of the workability retention agent is demonstrated by the workability retention increase from 10 minutes to 45 minutes. The 2 examples also show that the initial fresh properties and the final mechanical properties are not affected by the addition of the workability retention agent. Following examples 3-4 show different mix designs using various binder content and various binder compositions, using the workability retention agent to ensure workability retention of at least 45 minutes.

### Example 3—Concrete S4 Flow Class

| Material | Unit | Quantity |
|---|---|---|
| Total binder content | kg/m³ | 450 |
| Fly ash reference (Table 3) | — | MEL |
| Fly ash content | kg/m³ | 340 |
| Slag reference (Table 4) | — | GER |
| Slag content | kg/m³ | 110 |
| w/b eff | — | 0.38 |
| Slag/fly ash ration | Kg/Kg | 0.32 |
| Activator 1 dosage | Molarity Mol | 2 |
| Activator 2 dosage | Morality Mol | 5 |
| Total solid content (SC) of activators 1 | % SC total binder in | 16 |
| and 2 | weight content | |
| Workability retention agent dosage | % SC total binder | 0.6 |
| | content | |
| Sand 0/4 round | kg/m³ | 679 |
| Fine aggregates gravel 4/8 round | kg/m³ | 426 |
| Coarse aggregates gravel 8/16 round | kg/m³ | 475 |
| Entrained air | l/m³ | 18 |
| Paste Volume | l/m³ | 386 |
| Results | Unit | Value |
| Slump class | — | S4 |
| Slump flow | mm | 220 |
| Workability retention | min | 45 |
| Strength at 1 days | Mpa | 2.05 |
| Strength at 7 days | Mpa | 13.8 |
| Strength at 28 days | Mpa | 23.9 |

### Example 4—Concrete SF2 Flow Class

| Material | Unit | Quantity |
|---|---|---|
| Total binder content | kg/m³ | 350 |
| Fly ash reference (table 3) | — | LA |
| Fly ash content | kg/m³ | 350 |
| Slag reference (table 4) | — | — |
| Slag content | kg/m³ | 0 |
| w/b eff | — | 0.42 |
| Slag/fly ash ration | Kg/Kg | — |
| Activator 1 dosage | Molarity Mol | 2.3 |
| Activator 2 dosage | Morality Mol | 6 |
| Total solid content (SC) of | % SC total binder in | 20 |
| activators 1 and 2 | weight content | |
| Workability retention agent dosage | % SC total binder | 1.2 |
| | content | |
| Sand 0/4 round | kg/m³ | 726 |
| Fine aggregates gravel 4/8 round | kg/m³ | 456 |
| Coarse aggregates gravel 8/16 | kg/m³ | 508 |
| round | | |
| Entrained air | l/m³ | 2.2% |
| Paste Volume | l/m³ | 338 |
| Results | Unit | Value |
| Slump class | — | SF2 |
| Slump flow | mm | 670 |
| Workability retention | min | 60 |
| Strength at 1 days | Mpa | 2.1 |
| Strength at 7 days | Mpa | 4.5 |
| Strength at 28 days | Mpa | 20.0 |

### Example 5—Concrete S1 Flow Class—Specific Mix Design Elaborated for the Production of Concrete Pipes for Sewages

The concrete was produced on a central mixer using conventional techniques and procedures. The concrete was transported by belt conveyors to the different casting units. Different sizes RCP were produced by “dry cast” and by “packer head” methods.

| Material | Unit | Quantity |
|---|---|---|
| Total binder content | kg/m³ | 400 |
| Fly ash reference (table 3) | — | STO |
| Fly ash content | kg/m³ | 400 |
| Slag reference (table 4) | — | — |
| Slag content | kg/m³ | 0 |
| w/b eff | — | 0.32 |
| Slag/fly ash ration | Kg/Kg | — |
| Activator 1 dosage | Molarity Mol | 1.8 |
| Activator 2 dosage | Morality Mol | 4.7 |
| Total solid content (SC) of activators 1 | % SC total binder in | 12 |
| and 2 | weight content | |
| Workability retention agent dosage | % SC total binder | 1.2 |
| | content | |
| Sand 0/4 crushed | kg/m³ | 827 |
| Fine aggregates gravel 4/8 crushed | kg/m³ | 570 |
| Coarse aggregates gravel 8/11 crushed | kg/m³ | 329 |
| Entrained air | l/m³ | 20 |
| Paste Volume | l/m³ | 322 |
| Results | Unit | Value |
| Slump class | — | S1 |
| Slump flow | mm | <50 |
| Workability retention | min | 60 |
| Strength at 1 days* | Mpa | 14.57 |
| Strength at 7 days | Mpa | 16.72 |
| Strength at 28 days | Mpa | 23.22 |

*Samples were steam cured at 60° C. for 12 h before normal curing conditions

### Example 6—Concrete S1 Flow Class—Specific Mix Design Elaborated for the Production of Concrete Pipes for Sewages

The concrete was produced on a central mixer using conventional techniques and procedures. The concrete was transported by belt conveyors to the different casting units. Different sizes RCP were produced by “Hawk Eye” equipment.

| Material | Unit | Quantity |
|---|---|---|
| Total binder content | kg/m³ | 350 |
| Fly ash reference (table 3) | — | ALE |
| Fly ash content | kg/m³ | 350 |
| Slag reference (table 4) | — | — |
| Slag content | kg/m³ | 0 |
| w/b eff | — | 0.33 |
| Slag/fly ash ration | Kg/Kg | — |
| Activator 1 dosage | Molarity Mol | 1.5 |
| Activator 2 dosage | Morality Mol | 3 |
| Total solid content (SC) of activators 1 | % SC total binder in | 8 |
| and 2 | weight content | |
| Workability retention agent dosage | % SC total binder | 1.5 |
| | content | |
| Sand 0/4 crushed | kg/m³ | 944 |
| Fine aggregates gravel 4/8 crushed | kg/m³ | 946 |
| Coarse aggregates gravel 8/11 crushed | kg/m³ | — |
| Entrained air | l/m³ | 20 |
| Paste Volume | l/m³ | 274 |
| Results | Unit | Value |
| Slump class | — | S1 |
| Slump flow | mm | <50 |
| Workability retention | min | 120 |
| Strength at 1 days* | Mpa | 12.7 |
| Strength at 7 days | Mpa | 18.5 |
| Strength at 28 days | Mpa | 24.9 |

*Samples were steam cured at 60° C. for 12 h before normal curing conditions

Alternatively, the castable material according to the invention may advantageously contain high strength fibers (steel or aramid or carbon or glass fiber or mineral fibers), organic or synthetic fibers.

Alternatively, the concrete mix of the invention may have a partial of full substitution of the sand and aggregates with lightweight sand and aggregates (expanded shale, expanded clay, expanded glass or pumice, natural puzzolans, etc.). This enables to obtain lightweight structural fiber reinforced concretes with densities below 1800 kg/m³, preferably below 1600 Kg/m³ or even more preferably below 1400 kg/m³, to reduce the weight of the structural element and to increase the thermal resistance (or reduce the thermal conductivity)

Finally, the castable material according to the invention may contain other type of admixtures like air entrainers to increase the amount of controlled air in the final hardened product, water reducers and plasticizers or superplasticizers, etc.

The invention provides many advantages that could not be achieved before:
the invention enables using high dosages of fly ash in the binder (over 75% of fly ash in weight % to 100% fly ash), thus reducing the costs of raw materials and providing a solution that can be used in many location where good quality slag is not available.
the invention enables to achieve workability retention of at least 45 minutes irrespective of the initial flow of the fresh castable material.
the invention can be used for pipes manufacturing, more specifically for sewage pipes, using the excellent chemical, sulfates and acid resistance of alkali activated puzzolanas in comparison to normal cement based concrete
the invention enables using the castable material for in situ job casting requiring various fresh placement properties (pavement, building, infrastructure, marine application, etc.) as well as for pre-cast industry.

1. A castable construction material with controlled flow and workability retention comprising:
(a) a binder comprising from 75% to 100% by weight of fly ashes comprising from 1.5% to 35% by weight of CaO and a Lost on Ignition (LOI) value from 0.5% to 5.5% by weight,
(b) an activator comprising an alkali hydroxide and an alkali silicate, wherein the activator is from 3% to 25% by weight with respect to the castable construction material,
(c) sand,
(d) fine aggregates,
(e) coarse aggregates,
(f) free water and
(g) a workability retention agent wherein selected from the group consisting of polycarboxylate ether polymer (PCE), polyamines, polyethylene imines, polyacrylamides, polyacrylate (EO, PO) ester, polymethacrylate (EO, PO) ester, polyammonium derivatives and co-polymers thereof, polydiallyldimethylammonium chloride, benzalkonium chlorides, substituted quaternary ammonium salts, chitosans, caseins and cationically modified colloidal silica.

2. Castable construction material according to claim 1, further comprising an element selected from the group consisting of from 0% to 25% by weight of ground granulated blast furnace slag comprising from 40 to 70% by weight of CaO and from 30 to 60% by weight of SiO₂; from 0% to 25% by weight of pozzolans comprising from 4 to 7% by weight alkali and a Lost on Ignition (LOI) value from 0.01% to 7; and from 0% to 25% in weight of any combination of slag and pozzolans.

3. Castable construction material according to claim 1, wherein the ratio alkali hydroxide/alkali silicate is from 1:1.5 to 1:2.5.

4. Castable construction material according to claim 1, wherein said alkali hydroxide is in solution, wherein the weight solid content of said alkali hydroxide in the solution is from 30 to 50% by weight and the molarity of said alkali hydroxide in the solution (mole per liter of free added water) is from 2.5 to 6.

5. Castable construction material according to claim 1, wherein said alkali silicate is in solution, wherein the weight solid content of said alkali silicate in the solution is from 30 to 50% by weight and the molarity of said alkali hydroxide in the solution (mole per liter of free added water) is from 1 to 2.5.

6. Castable construction material according to claim 1, wherein the concentration range of said polycarboxylate ether polymer is from 0.12% to 0.75% by weight of total binder.

7. Castable construction material according to claim 1, wherein concentration of fly ashes is from 80% to 100% by weight.

8. Castable construction material according to claim 1, wherein said alkali silicate is sodium metasilicate.

9. Castable construction material according to claim 5, wherein the molarity of said alkali silicate is from 1 to 1.8.

10. Castable construction material according to claim 5, wherein the molarity of said alkali silicate is from 1.2 to 2.0.

11. Castable construction material according to claim 5, wherein the molarity of said alkali silicate is from 1.5 to 2.2.

12. Castable construction material according to claim 5, wherein the molarity of said alkali silicate is from 1.8 to 2.3.

13. Castable construction material according to claim 5, wherein the molarity of said alkali silicate is from 2 to 2.5.

14. Castable construction material according to claim 1, wherein said workability retention agent is in a dosage in dry solid content from 0.15 to 0.6%.

15. Castable construction material according to claim 1, wherein said workability retention agent is in a dosage in dry solid content from 0.6 to 1.2%.

16. Castable construction material according to claim 1, wherein said workability retention agent is in a dosage in dry solid content from 1.2 and 1.6%.
